(19) United States
(12) Patent Application Publication
(10) Pub. No.: US 2026/0014863 A1
(43) Pub. Date: Jan. 15, 2026

(54) SERVER AND METHOD FOR PROVIDING INFORMATION

(71) Applicants: HYUNDAI MOTOR COMPANY, Seoul (KR); KIA CORPORATION, Seoul (KR)

(72) Inventors: Dae Kun Lee, Yongin-si (KR); Seung Yeon Lee, Seoul (KR)

(73) Assignees: HYUNDAI MOTOR COMPANY, Seoul (KR); KIA CORPORATION, Seoul (KR)

(21) Appl. No.: 18/659,284

(22) Filed: May 9, 2024

(30) Foreign Application Priority Data
Nov. 6, 2023 (KR) 10-2023-0151859

(51) Int. Cl. B60K 35/28; B60K 35/81; H04W 4/40

(52) U.S. Cl. CPC B60K 35/28; B60K 35/81; B60K 2360/16; H04W 4/40

(57) ABSTRACT

A server and a method for providing information are disclosed. The server includes a collection unit configured to collect service provider usage information of consumers regarding each of a plurality of service providers present in each preset area. The server includes a bidding execution unit configured to perform bidding for each area based on the service provider usage information collected by the collection unit. The server includes a vehicle control unit configured to control a display device provided in at least one vehicle to output service provider information on a successful bidder, present in an area in which the bidding has been performed, among a plurality of service providers to the at least one vehicle, when the display device provided in the at least one vehicle displays the area in which the bidding has been performed. The at least one vehicle communicates with the server.

### CROSS-REFERENCE TO THE RELATED APPLICATION

This application claims priority to Korean Patent Application No. 10-2023-0151859, filed on Nov. 6, 2023, in the Korean Intellectual Property Office, the disclosure of which is incorporated herein by reference in its entirety.

### BACKGROUND

### 1. Field of the Disclosure

The present disclosure relates to a server and a method for providing specific information to a vehicle.

### 2. Description of the Related Art

A conventional navigation system installed in a vehicle displays the current location and direction of the vehicle through a display unit using data received from global positioning system (GPS) satellites. When a starting point and a destination are input thereto, the conventional navigation system provides roads and distances the vehicle will travel, expected time, and the like by displaying the same on a screen.

In addition, the navigation system receives real-time traffic information, presets an optimal distance or road priority using the received traffic information, the current location of the vehicle, and internally stored map information, and provides a service of providing information on a route determined based on preset information when a user performs route search. However, the navigation system can provide various functions, such as a radio function, a media function, and a location sharing functions to users as well as route guidance.

Recently, as time users spend in vehicles increases, it may be necessary to provide functions or services for increasing user convenience using a navigation system. In particular, it may be necessary to exclusively expose specific information among a lot of information through a navigation system.

The subject matter described as background technology above is only for the purpose of improving understanding of the background of the present disclosure. The above subject matter should not be taken as acknowledgment that is corresponds to prior art already known to those having ordinary skill in the art.

### SUMMARY OF THE DISCLOSURE

Therefore, the present disclosure has been made in view of the above problems. Objects of the present disclosure are to provide an information provision server and a method for performing bidding on a plurality of service providers used by consumers in a specific area and outputting only information on a successful bidder in that area.

The objects of the present disclosure are not limited to the objects mentioned above. Other objects not mentioned herein should be more clearly understood by those having ordinary skill in the art from the following description.

In accordance with an aspect of the present disclosure, the above and other objects can be accomplished by a server for providing information. The server includes a collection unit configured to collect service provider usage information of consumers regarding each of a plurality of service providers present in each preset area. The server also includes a bidding execution unit configured to perform bidding for each area based on the service provider usage information collected by the collection unit. The server also includes a vehicle control unit configured to control a display device provided in at least one vehicle to output. Thus, service provider information on a successful bidder, present in an area in which the bidding has been performed, among a plurality of service providers is output to the at least one vehicle in response to a determination that the display device provided in the at least one vehicle displays the area in which the bidding has been performed. The at least one vehicle is configured to communicate with the server.

For example, the collection unit may be further configured to collect the service provider usage information on each of the plurality of service providers from the at least one vehicle.

For example, the collection unit may be further configured to collect the service provider usage information from the at least one vehicle based on information on use of an in-vehicle payment function provided in the at least one vehicle.

For example, the collection unit may be further configured to collect the service provider usage information from the at least one vehicle based on at least one of preset point of interest (POI) information, location information, or information on a time spent at a specific location with respect to the at least one vehicle, in response to a determination that the collection unit is not able to collect the service provider usage information from the at least one vehicle based on the information on use of the in-vehicle payment function.

For example, the bidding execution unit may be further configured to analyze the collected service provider usage information and perform bidding for each area based on the analyzed information.

For example, the bidding execution unit may be further configured to provide the analyzed information to advertisers related to the plurality of service providers and perform bidding for each area through the advertisers.

For example, the service provider information may include at least one of brand information or location information of the plurality of service providers.

For example, in response to a determination that there is a successful bidder among the plurality of service providers for each area in the bidding, the bidding execution unit may be further configured to store service provider information on the successful bidder in a separately provided memory.

For example, the vehicle control unit may be further configured to collect display information of the display device provided in the at least one vehicle and determine whether the area in which the bidding has been performed is displayed on the display device.

For example, the vehicle control unit may be further configured to control the display device provided in the at least one vehicle to visually or audibly output the service provider information on the successful bidder to the at least one vehicle.

For example, the vehicle control unit may be further configured to control the display device to display, in the area in which the bidding has been performed, only service provider information on only one successful bidder in response to the determination that the display device provided in the at least one vehicle displays the area in which the bidding has been performed.

In accordance with another aspect of the present disclosure, a method of providing information includes collecting service provider usage information of consumers regarding each of a plurality of service providers present in each preset area. The method also includes performing bidding for each area based on the collected service provider usage information. The method also includes controlling a display device provided in at least one vehicle to output service provider information on a successful bidder, present in an area in which the bidding has been performed, among a plurality of service providers to the at least one vehicle, in response to a determination that the display device provided in the at least one vehicle displays the area in which the bidding has been performed. The at least one vehicle is configured to be connected to a server for mutual communication.

For example, collecting may include collecting the service provider usage information on each of the plurality of service providers from the at least one vehicle.

For example, collecting may include collecting the service provider usage information from the at least one vehicle based on information on use of an in-vehicle payment function provided in the at least one vehicle.

For example, collecting may include collecting the service provider usage information from the at least one vehicle based on at least one of preset point of interest (POI) information, location information, or information on a time spent at a specific location with respect to the at least one vehicle in response to a determination that it is not able to collect the service provider usage information from the at least one vehicle based on the information on use of the in-vehicle payment function.

For example, performing bidding may include analyzing the collected service provider usage information and performing bidding for each area based on the analyzed information.

For example, performing bidding may include providing the analyzed information to advertisers related to the plurality of service providers and performing bidding for each area through the advertisers.

For example, the method may further include, in response to a determination that there is a successful bidder among the plurality of service providers for each area in the bidding, storing service provider information on the successful bidder in a separately provided memory after the performing of bidding.

For example, controlling may include collecting display information of the display device provided in the at least one vehicle and determining whether the area in which the bidding has been performed is displayed on the display device.

For example, controlling may include controlling the display device provided in the at least one vehicle to visually or audibly output the service provider information on the successful bidder to the at least one vehicle.

### BRIEF DESCRIPTION OF THE DRAWINGS

The above and other objects, features, and other advantages of the present disclosure should be more clearly understood from the following detailed description taken in conjunction with the accompanying drawings, in which:

FIG. 1 is a block diagram illustrating an information provision server according to an embodiment of the present disclosure;

FIG. 2 is a diagram illustrating a method in which information is provided according to an embodiment of the present disclosure; and

FIG. 3 is a flowchart illustrating a method of providing information according to an embodiment of the present disclosure.

### DETAILED DESCRIPTION OF THE PREFERRED EMBODIMENTS

In the following description of the embodiments disclosed in the present disclosure, a detailed description of known functions and configurations incorporated herein have been omitted where the detailed description may obscure the subject matter of the present disclosure. In addition, the accompanying drawings are provided only for helping to understand the embodiments disclosed in the present disclosure, do not limit the technical spirit disclosed herein, and include all changes, equivalents, and substitutes included in the spirit and scope of the present disclosure.

The terms “first” and/or “second” are used to describe various components, but such components are not limited by these terms. The terms are used to discriminate one component from another component.

When a component is said to be “coupled” or “connected” to another component, it should be understood that a third component may be present between the two components although the component may be directly coupled or connected to the other component. When a component is said to be “directly coupled” or “directly connected” to another component, it should be understood that no element is present between the two components.

An element described in the singular form is intended to include a plurality of elements unless the context clearly indicates otherwise.

In the present specification, it should be further understood that the terms “comprise” or “include” and variations thereof specify the presence of a stated feature, figure, step, operation, component, part or combination thereof. However, such terms do not preclude the presence or addition of one or more other features, figures, steps, operations, components, or combinations thereof.

Hereinafter, embodiments disclosed in the present specification are described in detail with reference to the attached drawings. Identical or similar components are assigned the same reference numerals, and redundant descriptions thereof have been omitted. When a component, device, element, or the like of the present disclosure is described as having a purpose or performing an operation, function, or the like, the component, device, element, or the like should be considered herein as being “configured to” meet that purpose or to perform that operation or function. Each component, device, element, and the like may separately embody or be included with a processor and a memory, such as a non-transitory computer readable media, as part of the apparatus.

An object of the present disclosure is to perform bidding on a plurality of companies used by consumers in a specific area and to output only information on a successful bidder in that area. In particular, in embodiments of the present disclosure, which are described below, it is assumed that the above-described object is achieved through a vehicle provided to correspond to a consumer.

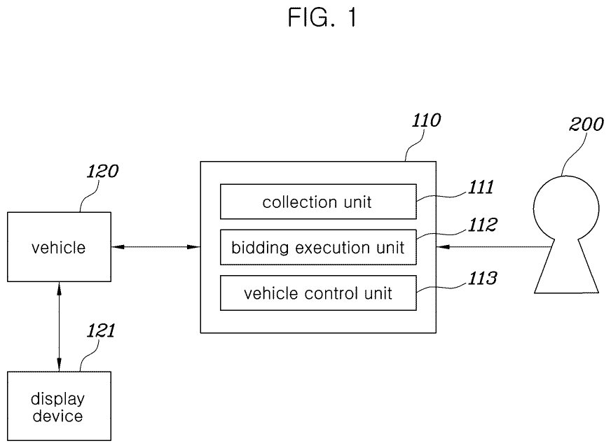

First, an information provision server according to an embodiment of the present disclosure is described with reference to FIG. 1.

FIG. 1 is a block diagram illustrating an information provision server according to an embodiment of the present disclosure.

Referring to FIG. 1, an information provision system according to an embodiment of the present disclosure may include the information provision server 110 and a vehicle 120. FIG. 1 mainly shows components related to the embodiment of the present disclosure, and the information provision system may include fewer or more components.

In addition, the information provision server 110 and the vehicle 120 may include a communication device for communicating with other devices (e.g., a controller or a sensor) to execute functions of each of the information provision server 110 and the vehicle 120, a memory in which an operating system, logic commands, input/output information, and the like are stored, and one or more processors that perform determination, computation, decision, etc. necessary for controlling the functions.

Hereinafter, each component is described.

Prior to describing the information provision server 110 according to an embodiment of the present disclosure, the information provision server 110 according to an embodiment of the present disclosure may be a vehicle server that is provided such that it can communicate with the vehicle 120 and provides various services to the vehicle 120. However, this is an example and the present disclosure is not necessarily limited thereto.

First, the information provision server 110 may collect service provider usage information of consumers regarding each of a plurality of service providers present in each preset area. Here, a preset area may be an area obtained by dividing a specific area or zone on a map into a plurality of small areas based on map information previously stored in the information provision server 110. However, this is an example, and the present disclosure is not necessarily limited thereto.

The information provision server 110 may be provided to correspond to at least one consumer and may collect service provider usage information of the consumer from at least one vehicle capable of communicating with the information provision server 110. Hereinafter, for convenience, description is made based on a single vehicle 120 capable of communicating with the information provision server 110. However, this is an example, and functions, which are described below, can be applied even when a plurality of vehicles is provided.

Specifically, the information provision server 110 according to an embodiment of the present disclosure may include a collection unit 111, a bidding execution unit 112, and a vehicle control unit 113.

Each component is described below.

The collection unit 111 may collect service provider usage information of consumers regarding each of a plurality of service providers present in each preset area from the vehicle 120 based on information on use of an in-vehicle payment function provided in the vehicle 120. Here, the in-vehicle payment function may be a payment function of allowing convenient payment without a physical card at affiliated stores as service providers, such as gas stations, car washes, restaurants, and parking lots, using the navigation system provided in the vehicle 120. For example, the in-vehicle payment function provided in the vehicle 120 may be an in-car payment function, but the present disclosure is not limited thereto.

If it is impossible to collect service provider usage information of consumers regarding each of a plurality of service providers present in each preset area based on the information on use of the in-vehicle payment function from the vehicle 120, the collection unit 111 may collect service provider usage information of consumers from the vehicle 120 based on at least one of preset point of interest (POI) information, location information, or information on a time spent at a specific location with respect to the vehicle 120. However, this is an example, and the present disclosure is not necessarily limited thereto.

Thereafter, the bidding execution unit 112 may perform bidding for each preset area based on the collected service provider usage information.

Specifically, the bidding execution unit 112 may analyze the collected service provider usage information and may perform bidding for each preset area based on the analyzed information. The bidding execution unit 112 may analyze information on at least one of the number of uses, total payment amount, or usage time for each of a plurality of service providers using the collected service provider usage information. In addition, the bidding execution unit 112 may provide the analyzed information to an advertiser 200 related to a plurality of service providers present in a preset area and may perform bidding for each preset area through the advertiser 200.

Here, the bidding execution unit 112 or the information provision server 110 may provide the analyzed information to the advertisers 200 through a terminal provided to correspond to each advertiser 200. There may be a plurality of advertisers 200, and each advertiser 200 may check the information provided from the information provision server 110 through a terminal provided to correspond thereto and participate in the bidding performed by the information provision server 110. For example, the terminal provided to correspond to each advertiser 200 may be a fixed terminal or a portable terminal, and in the case of a portable terminal, the terminal may be a smartphone, a laptop computer, a PDA, or the like. However, this is an example, and the present disclosure is not necessarily limited thereto.

Further, the bidding execution unit 112 may perform bidding for each preset area. If there is a successful bidder among a plurality of service providers for each preset area, the bidding execution unit 112 may store service provider information on the successful bidder in a separately provided memory. Here, the service provider information may include at least one of brand information or location information regarding the successful bidder, but the present disclosure is not limited thereto.

In addition, the vehicle control unit 113 may check whether an area in which bidding has been performed is displayed on the vehicle 120, capable of communicating with the vehicle control unit 113, through a display device 121 provided in the vehicle 120. For example, the display device 121 may be implemented as a cluster, a head-up display (HUD), or a display of an audio/video/navigation (AVN) system of the vehicle 120. However, this is an example, and various devices other than the aforementioned devices can be employed as the display device 121.

Specifically, the vehicle control unit 113 may collect display information of the display device 121 provided in the vehicle 120 and may determine whether an area in which bidding has been performed is displayed on the display device 121 based on the collected information.

For example, the vehicle 120 may receive display information from the display device 121 and may transmit the display information of the display device 121 to the vehicle control unit 113 through mutual communication with the information provision server 110. However, this is an example, and the present disclosure is not necessarily limited thereto. For example, if the display device 121 provided in the vehicle 120 and the information provision server 110 are capable of direct communication with each other, the display information of the display device 121 may be collected through communication between the display device 121 and the information provision server 110.

When the display device 121 provided in the vehicle 120 displays the area in which bidding has been performed, the vehicle control unit 113 may control the display device 121 to output service provider information on the successful bidder, present in the area in which bidding has been performed, among the plurality of service providers to the vehicle 120.

Here, the vehicle control unit 113 may control the display device 121 to visually or audibly output the service provider information on the successful bidder to the vehicle 120. In an embodiment of the present disclosure, the vehicle control unit 113 may control the display device 121 to display the service provider information on the successful bidder.

In particular, when the display device 121 provided in the vehicle 120 displays the area in which bidding has been performed, the vehicle control unit 113 may control the display device 121 to display, in the area in which bidding has been performed, only service provider information on only one successful bidder.

In addition, the vehicle control unit 113 may control the display device 121 of the vehicle 120 to display, in the form of a brand pin or displayed in the form of a pop-up in a brand pin, the service provider information on the successful bidder. However, this is an example, and the present disclosure is not necessarily limited to the above-described example.

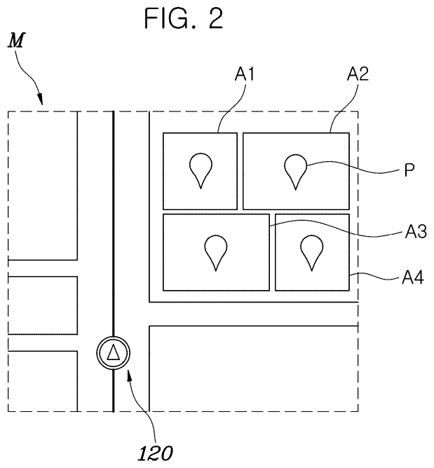

An embodiment related to this is described with reference to FIG. 2.

FIG. 2 is a diagram illustrating a method in which information is provided according to an embodiment of the present disclosure.

Referring to FIG. 2, if at least one area A1 to A4 in which bidding has been performed is displayed on a map screen M of the display device 121 provided in the vehicle 120, the information provision server 110 according to an embodiment of the present disclosure may cause only service provider information on a successful bidder among a plurality of service providers present in the at least one area A1 to A4 in which bidding has been performed to be displayed. For example, service provider information P on the successful bidder may be displayed in the form of a brand pin in each of the at least one area A1 to A4 on the map screen M of the display device 121 in the vehicle 120.

Accordingly, the driver or user of the vehicle 120 can intuitively check only information on one service provider with respect to the at least one area A1 to A4 and can perform exclusive promotion for the service provider in the at least one area A1 to A4.

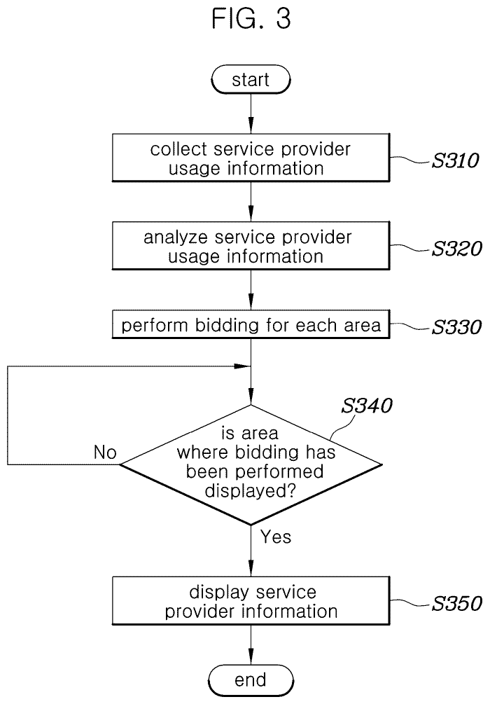

Hereinafter, an information provision method according to an embodiment is described with reference to FIG. 3 based on the configuration of the information provision server described above with reference to FIG. 1. A detailed description of each step has been described above with reference to FIG. 1 and thus has been omitted.

In addition, although each of the components constituting the information provision server 110 executes the corresponding function in FIG. 1, subjects that execute functions are integrated into the information provision server 110 in the following description for convenience.

FIG. 3 is a flowchart illustrating a method of providing information according to an embodiment of the present disclosure.

Referring to FIG. 3, the information provision server 110 may collect service provider usage information of consumers for each of a plurality of service providers present in each preset area (S310).

Then, the information provision server 110 may analyze the collected service provider usage information (S320) and may perform bidding for each preset area based on the analyzed information (S330). The information provision server 110 may determine whether the area in which the bidding has been performed is displayed on the display device 121 provided in the vehicle 120 (S340).

After the bidding is performed, when the area in which the bidding has been performed is displayed on the display device 121 provided in the vehicle 120 (Yes in S340), the information provision server 110 may cause the display device 121 of the vehicle 120 to display service provider information on a successful bidder, present in the area in which the bidding has been performed, among a plurality of service providers (S350).

According to the above, it is possible to ascertain service provider usage patterns of consumers and improve the usability of the in-vehicle payment function by collecting service provider usage information of the consumers based on information on use of the in-vehicle payment function through the information provision server and method of the present disclosure.

In addition, by performing bidding on a plurality of service providers present in each area, information on a successful bidder can be exclusively provided and the corresponding service provider can be actively promoted to consumers.

The effects that can be obtained from the present disclosure are not limited to the effects mentioned above. Other effects not mentioned herein can be more clearly understood by those having ordinary skill in the art from the description above.

Although specific embodiments of the present disclosure have been disclosed for illustrative purposes, those having ordinary skill in the art should appreciate that various modifications, additions, and substitutions are possible, without departing from the scope and spirit of the present disclosure as disclosed in the accompanying claims.

The embodiments of the above detailed description can be implemented as computer-readable code on a program-recorded medium. Computer-readable media include all types of recording devices that store data that can be read by a computer system. Examples of computer-readable media include a hard disk drive (HDD), a solid state drive (SSD), a silicon disk drive (SDD), a ROM, a RAM, a CD-ROM, a magnetic tape, a floppy disk, an optical data storage device, and the like. Accordingly, the above detailed description should not be construed as restrictive in all respects and should be considered illustrative. The scope of the present disclosure should be determined by reasonable interpretation of the appended claims, and all changes within the equivalent scope of the present disclosure are included in the scope of the present disclosure.

What is claimed is:

1. A server for providing information, comprising:
a collection unit configured to collect service provider usage information of consumers regarding each of a plurality of service providers present in each preset area;
a bidding execution unit configured to perform bidding for each area based on the service provider usage information collected by the collection unit; and
a vehicle control unit configured to control a display device provided in at least one vehicle to output service provider information on a successful bidder, present in an area in which the bidding has been performed, among a plurality of service providers to the at least one vehicle, in response to a determination that the display device provided in the at least one vehicle displays the area in which the bidding has been performed,
wherein the at least one vehicle is configured to communicate with the server.

2. The server of claim 1, wherein the collection unit is further configured to collect the service provider usage information on each of the plurality of service providers from the at least one vehicle.

3. The server of claim 2, wherein the collection unit is further configured to collect the service provider usage information from the at least one vehicle based on information on use of an in-vehicle payment function provided in the at least one vehicle.

4. The server of claim 3, wherein the collection unit is further configured to collect the service provider usage information from the at least one vehicle based on at least one of preset point of interest (POI) information, location information, or information on a time spent at a specific location with respect to the at least one vehicle, in response to a determination that the collection unit is not able to collect the service provider usage information from the at least one vehicle based on the information on use of the in-vehicle payment function.

5. The server of claim 1, wherein the bidding execution unit is further configured to analyze the collected service provider usage information and perform bidding for each area based on the analyzed information.

6. The server of claim 5, wherein the bidding execution unit is further configured to provide the analyzed information to advertisers related to the plurality of service providers and perform bidding for each area through the advertisers.

7. The server of claim 1, wherein the service provider information includes at least one of brand information or location information of the plurality of service providers.

8. The server of claim 1, wherein, in response to a determination that there is a successful bidder among the plurality of service providers for each area in the bidding, the bidding execution unit is further configured to store service provider information on the successful bidder in a separately provided memory.

9. The server of claim 1, wherein the vehicle control unit is further configured to collect display information of the display device provided in the at least one vehicle and determine whether the area in which the bidding has been performed is displayed on the display device.

10. The server of claim 1, wherein the vehicle control unit is further configured to control the display device provided in the at least one vehicle to visually or audibly output the service provider information on the successful bidder to the at least one vehicle.

11. The server of claim 1, wherein the vehicle control unit is further configured to control the display device to display, in the area in which the bidding has been performed, only service provider information on only one successful bidder in response to the determination that the display device provided in the at least one vehicle displays the area in which the bidding has been performed.

12. A method of providing information, comprising:
collecting service provider usage information of consumers regarding each of a plurality of service providers present in each preset area;
performing bidding for each area based on the collected service provider usage information; and
controlling a display device provided in at least one vehicle to output service provider information on a successful bidder, present in an area in which the bidding has been performed, among a plurality of service providers to the at least one vehicle, in response to a determination that the display device provided in the at least one vehicle displays the area in which the bidding has been performed,
wherein the at least one vehicle is configured to be connected to a server for mutual communication.

13. The method of claim 12, wherein collecting comprises collecting the service provider usage information on each of the plurality of service providers from the at least one vehicle.

14. The method of claim 13, wherein collecting comprises collecting the service provider usage information from the at least one vehicle based on information on use of an in-vehicle payment function provided in the at least one vehicle.

15. The method of claim 14, wherein collecting comprises collecting the service provider usage information from the at least one vehicle based on at least one of preset point of interest (POI) information, location information, or information on a time spent at a specific location with respect to the at least one vehicle, in response to a determination that it is not able to collect the service provider usage information from the at least one vehicle based on the information on use of the in-vehicle payment function.

16. The method of claim 12, wherein performing bidding comprises analyzing the collected service provider usage information and performing bidding for each area based on the analyzed information.

17. The method of claim 16, wherein performing bidding comprises providing the analyzed information to advertisers related to the plurality of service providers and performing bidding for each area through the advertisers.

18. The method of claim 12, further comprising, in response to a determination that there is a successful bidder among the plurality of service providers for each area in the bidding, storing service provider information on the successful bidder in a separately provided memory after the performing of bidding.

19. The method of claim 12, wherein controlling comprises collecting display information of the display device provided in the at least one vehicle and determining whether the area in which the bidding has been performed is displayed on the display device.

20. The method of claim 12, wherein controlling comprises controlling the display device provided in the at least one vehicle to visually or audibly output the service provider information on the successful bidder to the at least one vehicle.
